(19) United States
(12) Patent Application Publication
(10) Pub. No.: US 2024/0126150 A1
(43) Pub. Date: Apr. 18, 2024

(54) SUPPORT STAND FOR PHOTOGRAPHY

(71) Applicant: Shenzhen Weiji Technology Co.,Ltd., Shenzhen (CN)

(72) Inventors: Qingqing ZOU, Shenzhen (CN); Wei WEI, Shenzhen (CN); Xinzhi WANG, Shenzhen (CN); Youjin XIAO, Shenzhen (CN); Jun ZHANG, Shenzhen (CN); Jianxiong XIA, Shenzhen (CN)

(73) Assignee: Shenzhen Weiji Technology Co.,Ltd., Shenzhen (CN)

(21) Appl. No.: 18/157,048

(22) Filed: Jan. 19, 2023

(30) Foreign Application Priority Data
Oct. 13, 2022 (CN) 202222704496.3

(51) Int. Cl. G03B 17/56; F16M 11/08; F16M 11/32

(52) U.S. Cl. CPC G03B 17/561; F16M 11/08; F16M 11/32

(57) ABSTRACT

A support stand for photography includes a support main body having supporting ends and a mounting end and an adapting device provided at the mounting end. The supporting ends are formed on supporting legs of the support main body. The supporting legs can be unfolded to allow two adjacent supporting ends to move away from each other. The supporting legs can be folded to allow the two adjacent supporting ends to move close to each other and form a gap between two adjacent supporting legs. The adapting device includes a fixed seat provided with an adapting structure for mounting a first photographic equipment and a clamping seat configured to clamp a second photographic equipment. The clamping seat is rotatably connected to the fixed seat. The clamping seat can rotate toward a side where the supporting ends are located to be accommodated in the gap between the two adjacent supporting legs.

### CROSS REFERENCE TO THE RELATED APPLICATIONS

This application is based upon and claims priority to Chinese Patent Application No. 202222704496.3, filed on Oct. 13, 2022, the entire contents of which are incorporated herein by reference.

### TECHNICAL FIELD

The present disclosure relates to the technical field of photographic equipment, in particular, to a support stand for photography.

### BACKGROUND

Support stands in existing markets for photographic equipment essentially fix only one photography accessory. For example, they are used to fix either a camera or a mobile phone and cannot fix at least two photography accessories, which cannot meet multiple requirements of users in an all-around manner and brings inconvenience to the users. Particularly in some scenarios where both the mobile phone and the camera need to be fixed by the support stand at the same time, the support stands in existing markets are far from satisfactory and cause poor user experience.

### SUMMARY

An objective of the present disclosure is to provide a support stand for photography, to solve the problem that support stands in existing markets cannot fix at least two photography accessories, which is an inconvenience to users.

To solve the above technical problem, the present disclosure adopts the following technical solutions.

According to a first aspect, the present disclosure provides a support stand for photography, including:
a support main body having supporting ends and a mounting end that are positioned oppositely along an axial direction of the support main body, and including a plurality of supporting legs. The supporting ends are formed on the supporting legs. The plurality of supporting legs can be unfolded to allow two adjacent supporting ends to move away from each other. The plurality of supporting legs can be folded to allow the two adjacent supporting ends to move close to each other and form a gap between two adjacent supporting legs;
an adapting device provided at the mounting end, and including a fixed seat and a clamping seat. The fixed seat is provided with an adapting structure. The adapting structure is configured to mount the first photographic equipment. The clamping seat is configured to clamp the second photographic equipment. The clamping seat is rotatably connected to the fixed seat. The clamping seat can rotate toward a side where the supporting ends are located to be accommodated in the gap between the two adjacent supporting legs.

According to a second aspect, the present disclosure provides a support stand for photography, including:
a support main body having supporting ends and a mounting end that are positioned oppositely along an axial direction of the support main body; and
an adapting device provided at the mounting end, and including a fixed seat and a clamping seat. The fixed seat is provided with an adapting structure. The adapting structure is configured to mount the first photographic equipment. The clamping seat is configured to clamp the second photographic equipment. The clamping seat is rotatably connected to the fixed seat. The clamping seat can rotate toward a side where the supporting ends are located, such that the clamping seat is arranged side by side with the support main body.

According to a third aspect, the present disclosure provides a support stand for photography, including:
a support main body having supporting ends and a mounting end that are positioned oppositely along an axial direction of the support main body; and
an adapting device provided at the mounting end, and including a fixed seat and a clamping seat. The fixed seat is provided with an adapting structure. The adapting structure is configured to mount the first photographic equipment. The clamping seat is configured to clamp the second photographic equipment. The clamping seat is rotatably connected to the fixed seat. The clamping seat can rotate toward a side where the supporting ends are located, such that the length direction of the clamping seat is parallel to the axial direction.

According to a fourth aspect, the present disclosure provides a support stand for photography, including:
a support main body having supporting ends and a mounting end that are positioned oppositely along an axial direction of the support main body; and
an adapting device provided at the mounting end, and including a fixed seat and a clamping seat. The fixed seat is provided with an adapting structure. The adapting structure is configured to mount the first photographic equipment. The clamping seat includes a mounting portion, a clamping portion, and an extension arm between the mounting portion and the clamping portion. The mounting portion is connected to the fixed seat. The clamping portion is configured to clamp the second photographic equipment. Two opposite ends of the extension arm are rotatably connected to the mounting portion and the clamping portion respectively. The axis of rotation between the extension arm and the mounting portion is defined as a first axis. The axis of rotation between the clamping portion and the extension arm is defined as a second axis. The first axis and the second axis are perpendicular to each other.

According to the above technical solutions, the embodiments of the present disclosure have at least the following beneficial effects.

According to the support stand for photography provided by the embodiments of the present disclosure, the mounting end of the support main body is provided with the fixed seat and the clamping seat at the same time, and the first photographic equipment and the second photographic equipment can be respectively mounted on the fixed seat and the clamping seat. Therefore, the support stand for photography can fix at least two different photography accessories at the same time to meet multiple requirements of users. Since the clamping seat is further rotatably connected to the fixed seat, the second photographic equipment on the clamping seat can be adjusted to an angle different from that of the first photographic equipment on the fixed seat. When the clamping seat is used unnecessarily, the clamping seat can further rotate toward a side where the supporting ends are located to move close to the support main body and form a storage state.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show some embodiments of the present disclosure, and those of ordinary skill in the art may still derive other drawings from these accompanying drawings without creative efforts.

FIG. 1 is a schematic structural view of a support stand for photography in an unfolded state according to a first embodiment of the present disclosure.

FIG. 2 is a schematic structural view of a support stand for photography in a folded state according to a first embodiment of the present disclosure.

FIG. 3 is a partially enlarged view of the support stand for photography in FIG. 1.

FIG. 4 is a partially enlarged view of the support stand for photography in FIG. 2.

FIG. 5 is an enlarged view of A in the support stand for photography in FIG. 1.

FIG. 6 is a schematic structural view of a support stand for photography in an unfolded state according to a second embodiment of the present disclosure.

FIG. 7 is a schematic structural view of a support stand for photography in a folded state according to a second embodiment of the present disclosure.

FIG. 8 is a partially enlarged view of the support stand for photography in FIG. 6.

### REFERENCE NUMERALS

10: support stand for photography, 100: support main body, 110: supporting end, 120: mounting end, 121: universal ball, 130: central rod, 140: slider, 150: supporting leg, 151: gap, 160: fastener, 200: adapting device, 210: fixed seat, 211: adapting structure, 212: seat body, 213: plate body, 214: button, 215: threaded shaft, 216: rotary knob, 220: clamping seat, 221: mounting portion, 222: clamping portion, 223: extension arm, 224: base plate, 225: first clamping member, 226: second clamping member, 227: first supporting arm, 228: second supporting arm, and 229: locking member.

### DETAILED DESCRIPTION OF THE EMBODIMENTS

The typical implementations embodying the features and advantages of the present disclosure are described in detail below. It should be understood that the present disclosure may have various changes in different implementations, which do not depart from the scope of the present disclosure. The description and drawings herein are essentially used for explanation, rather than to limit the present disclosure.

Moreover, the terms such as “first” and “second” are used only for the purpose of description and should not be construed as indicating or implying relative importance, or implicitly indicating a quantity of indicated technical features. Therefore, the features defined by “first” and “second” can explicitly or implicitly include one or more features. In the description of the present application, “a plurality of” means two or more, unless otherwise specifically defined.

It should be noted that, unless otherwise clearly specified, in the description of the present disclosure, meanings of the terms “mount”, “provide”, and “connect” should be understood in a broad sense. For example, a connection may be a fixed connection, a removable connection, or an integral connection; it may be a mechanical connection or an electrical connection; it may be a direct connection or an indirect connection via an intermediate medium; or it may be intercommunication between two components. Those of ordinary skill in the art may derive specific meanings of the above terms in the present disclosure based on specific situations.

### First Embodiment

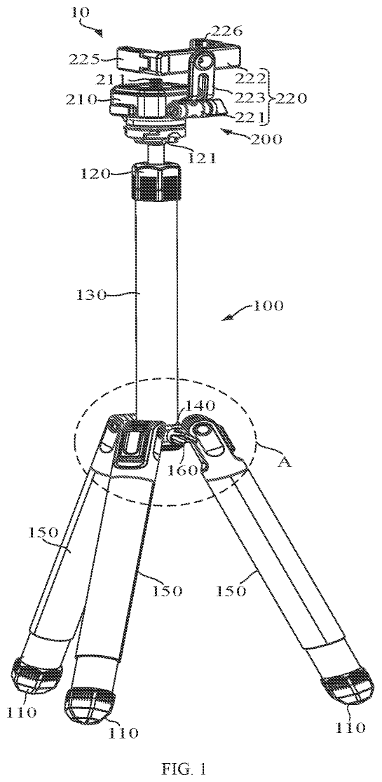

Referring to FIG. 1, the present disclosure provides support stand 10 for photography. The support stand 10 for photography includes support main body 100 and adapting device 200. The support main body 100 is supported on a flat or rough table or ground. The adapting device 200 is connected to an end of the support main body 100 away from the table or the ground. At least two types of photographic equipment cooperating in use can be provided on the adapting device 200. The photographic equipment may include, but is not limited to, a camera, a mobile phone, an illuminator, a flash lamp, etc.

The support main body 100 has supporting ends 110 and mounting end 120 that are positioned oppositely along an axial direction of the support main body 100. The supporting ends 110 are supported on a supporting surface, which may be the table or the ground. The mounting end 120 is configured to mount the adapting device 200, such that the support main body 100 can be externally connected to at least two types of photographic equipment.

The support main body 100 includes central rod 130, slider 140, and a plurality of supporting legs 150. The central rod 130 is provided with the mounting end 120, that is, the mounting end 120 is formed at one end of the central rod 130. The slider 140 slides on the central rod 130 along an axial direction of the central rod 130 and can move close to or away from the mounting end 120. The supporting legs 150 are provided with the supporting ends 110, that is, the supporting ends 110 are formed on the supporting legs 150. Sides of the plurality of supporting legs 150 away from the supporting ends 110 are connected to the slider 140. The axial movement of the slider 140 relative to the central rod 130 can drive the supporting legs 150 to move synchronously.

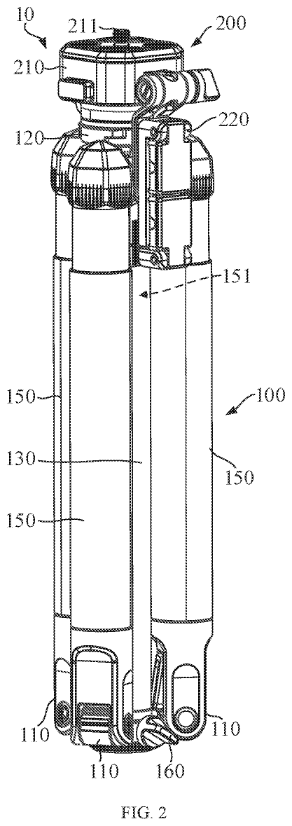

Referring to FIG. 1, when the slider 140 moves away from the mounting end 120 along the axial direction of the central rod 130 by a preset distance, the supporting legs 150 can be unfolded to allow two adjacent supporting ends 110 to move away from each other. The supporting legs 150 in an unfolded state provide a sufficiently stable supporting force for the supporting ends 110. Referring to FIG. 2, when the slider 140 moves close to the mounting end 120 along the axial direction of the central rod 130 by a preset distance, the supporting legs 150 can be folded to allow two adjacent supporting ends 110 to move close to each other. Gap 151 is further formed between two adjacent supporting legs 150 in a folded state. It is to be noted that although FIG. 1 illustrates that the supporting legs 150 are unfolded by moving the slider 140 away from the mounting end 120, and FIG. 2 illustrates that the supporting legs 150 are folded by moving the slider 140 close to the mounting end 120, there are also some scenarios where the slider 140 can further move to any position to fold or unfold the supporting legs 150. For example, it is also proposed to unfold and fix the supporting legs 150 when the slider 140 is close to the mounting end 120.

Although FIG. 1 and FIG. 2 illustrate that while the slider 140 moves axially relative to the central rod 130, the supporting legs 150 cannot be folded or unfolded under the driving action of the slider 140, some embodiments where the slider 140 can drive the supporting legs 150 to fold or unfold while moving axially relative to the central rod 130 also fall within the scope of protection of the present disclosure. For example, a connecting rod may be provided between each of the supporting legs 150 and the central rod 130. When the slider 140 moves axially away from the mounting end 120 relative to the central rod 130, the slider 140 drives the supporting legs 150 through the connecting rods to move, such that the supporting legs 150 are unfolded. It is to be noted that although the foregoing embodiment describes the support main body 100 exemplarily based on the folded or unfolded support stand, there are some embodiments where the support main body 100 may further be non-expandable. In this case, the support main body 100 can be understood as being non-switchable in the state, and the support main body 100 may be a handheld handle or rod.

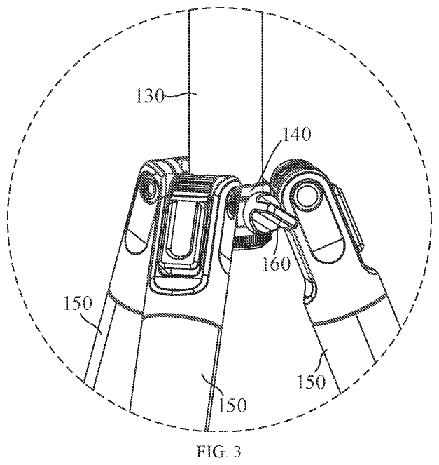

Referring to FIG. 3, the slider 140 is provided with fastener 160. The fastener 160 penetrates through the slider 140 and abuts against the central rod 130. The fastener 160 may be a threaded connecting piece. A degree of abutment between the fastener 160 and the central rod 130 may be adjusted by rotating the fastener 160, thereby controlling damping when the slider 140 slides along the central rod 130. For example, when the slider 140 moves to a preset position along the central rod 130, the slider 140 may be fixed relative to the central rod 130 by rotating the fastener 160. It is to be understood that the case where the fastener 160 controls the damping between the slider 140 and the central rod 130 merely serves as an example, a structure for adjusting the damping in any other forms may further be provided in other embodiments. For example, an oblique surface may be provided inside the slider 140, and pretightening between the oblique surface and the central rod 130 is realized by rotating the slider 140.

Since it is unnecessary to adjust an overall axial length of the support main body 100 by moving the slider 140 relative to the central rod 130 in some scenarios, the support stand 10 for photography is unnecessarily provided with the central rod 130 and the slider 140 in some embodiments. In this case, the support main body 100 may only include the plurality of supporting legs 150. Two opposite ends of the supporting legs 150 serve as the supporting ends 110 and the mounting end 120.

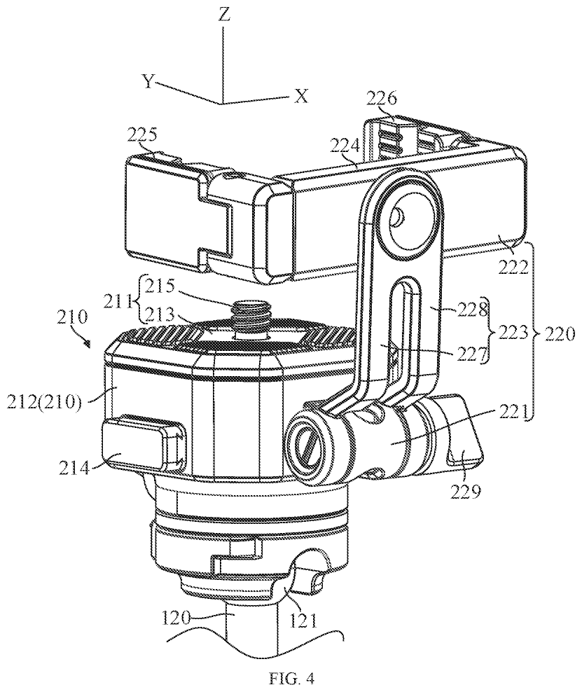

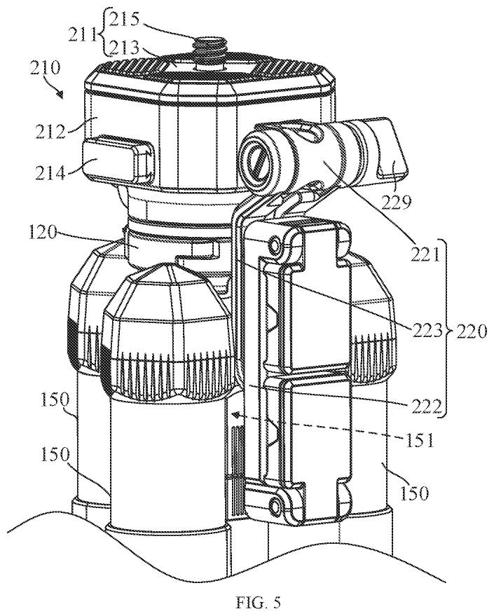

Referring to FIG. 4 and FIG. 5, the adapting device 200 is provided at the mounting end 120. At least two different types of photographic equipment can be mounted on the adapting device 200 at the same time. For ease of understanding, it is defined herein that the first photographic equipment and the second photographic equipment can be mounted on the adapting device 200. The first photographic equipment and the second photographic equipment may be the same or different. For example, when the first photographic equipment is a camera, the second photographic equipment may be a smartphone.

The adapting device 200 includes fixed seat 210 and clamping seat 220. The fixed seat 210 is provided with adapting structure 211. The adapting structure 211 is configured to mount the first photographic equipment. The clamping seat 220 is rotatably connected to the fixed seat 210. The clamping seat 220 can rotate toward a side where the supporting ends 110 are located, such that at least one part of the clamping seat is accommodated in the gap 151 between the two adjacent supporting legs 150. It is to be understood that two adjacent supporting legs 150 in the folded state are unnecessarily provided therebetween with the gap 151. For example, the plurality of supporting legs 150 in the folded state may also enclose to form a tubular structure around the central rod 130. In a case where two adjacent supporting legs 150 cannot form the gap 151, the clamping seat 220 can rotate toward the side where the supporting ends 110 are located, such that the clamping seat 220 is provided side by side with the support main body 100. Alternatively, as another understanding, the length direction of the clamping seat 220 is parallel to the axial direction of the support main body 100. It is to be understood that the gap 151 is also applicable to the embodiment where the clamping seat 220 is provided side by side with the support main body 100, and the embodiment where the length direction of the clamping seat 220 is parallel to the axial direction of the support main body 100. It is to be noted that the so-called term “side by side” unnecessarily indicates that the length direction of the clamping seat 220 is parallel to the axial direction of the support main body 100. In a case where the clamping seat 220 is attached to the support main body 100, the length direction of the clamping seat 220 is oblique to the axial direction of the support main body 100, which is also understood as being “side by side”.

According to the support stand 10 for photography provided by the embodiment of the present disclosure, the mounting end 120 of the support main body 100 is provided with the fixed seat 210 and the clamping seat 220 at the same time, and the first photographic equipment and the second photographic equipment can be respectively mounted on the fixed seat 210 and the clamping seat 220. Therefore, the support stand for photography can fix at least two different photography accessories at the same time to meet multiple requirements of users. Since the clamping seat 220 is further rotatably connected to the fixed seat 210, the second photographic equipment on the clamping seat 220 can be adjusted to an angle different from that of the first photographic equipment on the fixed seat 210. When the clamping seat 220 is used unnecessarily, the clamping seat 220 can further rotate toward a side where the supporting ends 110 are located to move close to the support main body 100 and form a storage state.

The adapting structure 211 includes at least one of a threaded shaft, a threaded hole, a quick-release seat and a quick-release plate. For example, as shown in FIG. 4 and FIG. 5, the adapting structure 211 is a quick-release seat with threaded shaft 215. Specifically, the quick-release seat includes seat body 212, plate body 213, and button 214. The seat body 212 is connected to the fixed seat 210. As shown, the seat body 212 and the fixed seat 210 are of an integrally formed structure. The plate body 213 is provided with the threaded shaft 215. The threaded shaft 215 is configured to externally connect the first photographic equipment with a threaded hole. The plate body 213 can cover the seat body 212 and is buckled with the button 214, which allows a spring connected to the button 214 to accumulate an elastic force. When the plate body 213 is to be released from the seat body 212, the button 214 can be pressed manually to overcome the elastic force of the spring, such that the button 214 is no longer buckled with the plate body 213, and the plate body 213 can be released quickly.

Also as shown in FIG. 4, a part of the clamping seat 220 for clamping the second photographic equipment can be located at a side of the adapting structure 211 away from the support main body 100, namely the position where the part of the clamping seat 220 for clamping the second photographic equipment is located is higher than the position where the adapting structure 211 is located, which can reduce or prevent interference between the first photographic equipment and the second photographic equipment as much as possible, and ensure a cooperative effect between the two pieces of photographic equipment. It is to be understood that the heights of the two positions may also be in other structural relationships in other embodiments, and may, for example, be the same.

Also as shown in FIG. 4, universal ball 121 is provided at the mounting end 120. The fixed seat 210 is connected to the universal ball 121 and can swing relative to the universal ball 121, such that an overall placement angle of the adapting structure 211 can be adjusted with one component. Certainly, the universal ball 121 is further provided with a locking device. The locking device is configured to lock the universal ball 121 and the fixed seat 210 to prevent the fixed seat 210 from swinging to an expected angle from swinging continuously. The specific structure of the locking device may refer to the foregoing specific description on the fastener 160, and will not be repeated.

Referring to FIG. 4 and FIG. 5, the clamping seat 220 includes mounting portion 221, clamping portion 222, and extension arm 223 between the mounting portion 221 and the clamping portion 222. The mounting portion 221 is connected to the fixed seat 210. Two opposite ends of the extension arm 223 are rotatably connected to the mounting portion 221 and the clamping portion 222 respectively. The clamping portion 222 is configured to clamp the second photographic equipment. For ease of understanding, the axis of rotation between the extension arm 223 and the mounting portion 221 is defined as a first axis. The axis of rotation between the clamping portion 222 and the extension arm 223 is defined as a second axis. The first axis and the second axis are perpendicular to each other and further perpendicular to the axial direction of the support main body 100. The first axis may refer to an X-axis direction in FIG. 4. The second axis may refer to a Y-axis direction in FIG. 4. The axial direction of the support main body 100 may refer to a Z-axis direction in FIG. 4. It is to be noted that the first axis and the second axis may further not be perpendicular to the axial direction of the support main body 100 in some embodiments, provided that the clamping seat 220 has at least two degrees of freedom (DOFs) around the first axis and the second axis. In this way, the clamping seat 220 can provide a more flexible mounting space for the first photographic equipment on the fixed seat 210. When the clamping seat 220 is used unnecessarily, the clamping seat 220 may further move close to the support main body 100 and thus the clamping seat 220 is located at an appropriate storage position.

Based on the above structural design, the second photographic equipment on the clamping portion 222 has a more flexible DOF, which facilitates switching to a storage state, that is, the clamping portion 222 and the extension arm 223 can rotate toward a side where the support main body 100 is located, such that the clamping portion 222 and the extension arm 223 can be at least partially accommodated in the gap 151. Alternatively, the clamping portion 222 and the extension arm 223 can be provided side by side with the support main body 100, or the length direction of the clamping seat 220 is parallel to the axial direction of the support main body 100. It is to be understood that the clamping portion 222 may also not rotate relative to the extension arm 223. In this case, the length direction of the clamping portion 222 is always parallel to the axial direction of the support main body 100, such that when the extension arm 223 rotates around the first axis, the clamping portion 222 can be located in the storage state.

In an embodiment, the clamping portion 222 includes base plate 224, first clamping member 225 and second clamping member 226, wherein the first clamping member 225 and the second clamping member 226 are arranged at two ends of the base plate 224. The two clamping members of the base plate 224 rotate around the second axis. Both the first clamping member 225 and the second clamping member 226 can clamp the second photographic equipment on the base plate 224. Specifically, the first clamping member 225 and the second clamping member 226 can move close to or away from each other to adjust a clamping space between the first clamping member 225 and the second clamping member 226. A spring is further provided between the first clamping member 225 and the second clamping member 226. Through the spring, the first clamping member 225 and the second clamping member 226 tend to move close to each other, thereby ensuring that the second photographic equipment can be clamped stably. In addition, the first clamping member 225 and the second clamping member 226 can further turn inward to be stacked on the base plate 224. Consequently, when the second photographic equipment is unnecessarily clamped on the base plate 224, the clamping seat 220 in the storage state has a smaller size and is more compact.

In an embodiment, the extension arm 223 includes first supporting arm 227 and second supporting arm 228. The first supporting arm 227 and the second supporting arm 228 are spaced from each other, and connected at a side where the clamping portion 222 is located. The first supporting arm 227 and the second supporting arm 228 are respectively arranged at two opposite ends of the mounting portion 221. The mounting portion 221 is further provided with locking member 229. The locking member 229 may be a threaded member. The locking member 229 penetrates through the first supporting arm 227, the mounting portion 221 and the second supporting arm 227 to rotatably adjust rotational damping between the extension arm 223 and the mounting portion 221. Structures of the first supporting arm 227 and the second supporting arm 228 not only facilitate the installation of the extension arm 223 on the mounting portion 221, but also ensure the stability of the extension arm 223 on the mounting portion 221.

### Second Embodiment

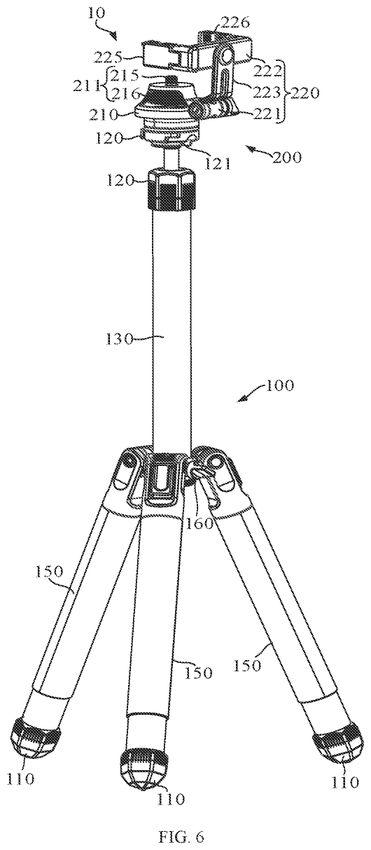

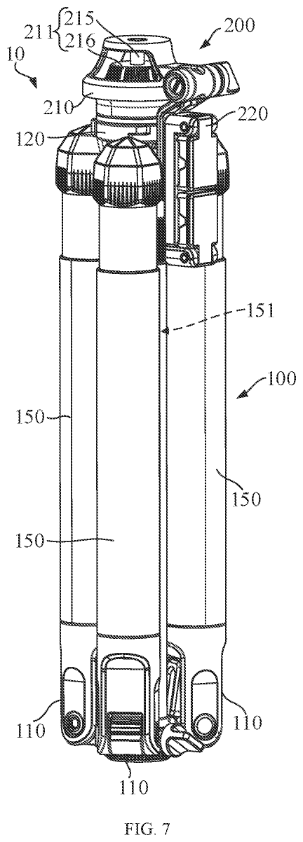

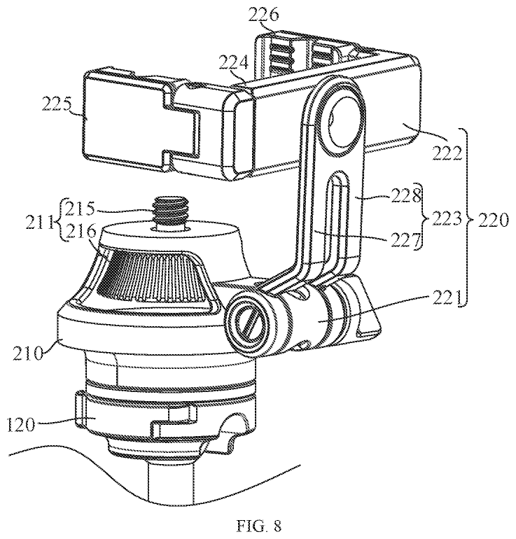

Referring to FIG. 6 to FIG. 8, FIG. 6 illustrates a schematic structural view of a support stand for photography in an unfolded state according to a second embodiment of the present disclosure, FIG. 7 illustrates a schematic structural view of a support stand for photography in a folded state according to a second embodiment of the present disclosure, and FIG. 8 illustrates a partially enlarged view of the support stand for photography in FIG. 6.

The support stand 10 for photography in the embodiment is essentially the same as the support stand 10 for photography in the first embodiment in structure, but the adapting structure 211 has a different structure. In the embodiment, the adapting structure 211 includes threaded shaft 215 and rotary knob 216. The rotary knob 216 is located inside the fixed seat 210. The threaded shaft 215 penetrates through the fixed seat 210 and is connected to the rotary knob 216. The rotary knob 216 can be artificially driven to rotate, such that the threaded shaft 215 exposed from the fixed seat 210 is connected or disconnected with the first photographic equipment with a threaded hole.

The present disclosure is described above by referring to several typical implementations. It should be understood that the terms used herein are intended for illustration, rather than as a limitation. The present disclosure may be specifically implemented in many forms without departing from the spirit or essence of the present disclosure. Therefore, it should be understood that the above embodiments are not limited to any of the above-mentioned details, but should be broadly interpreted according to the spirit and scope defined by the appended claims. Therefore, any changes and modifications falling within the claims or the equivalent scope thereof should be covered by the appended claims.

What is claimed is:

1. A support stand for photography, comprising:
a support main body having supporting ends and a mounting end, and comprising a plurality of supporting legs, wherein the supporting ends and the mounting end are positioned oppositely along an axial direction of the support main body, and the supporting ends are respectively formed on the plurality of supporting legs; the plurality of supporting legs are configured to be unfolded to allow two adjacent supporting ends to move away from each other; and the plurality of supporting legs are configured to be folded to allow the two adjacent supporting ends to move close to each other and form a gap between two adjacent supporting legs; and
an adapting device provided at the mounting end, and comprising a fixed seat and a clamping seat, wherein the fixed seat is provided with an adapting structure; the adapting structure is configured to mount a first photographic equipment; the clamping seat is configured to clamp a second photographic equipment; the clamping seat is rotatably connected to the fixed seat; and the clamping seat is configured to rotate toward a side where the supporting ends are located to be accommodated in the gap between the two adjacent supporting legs, wherein a length direction of the clamping seat is parallel to the axial direction of the support main body when the clamping seat is accommodated in the gap between the two adjacent supporting legs;
wherein the clamping seat comprises a mounting portion, a clamping portion, and an extension arm between the mounting portion and the clamping portion: the clamping portion comprises a base plate, a first clamping member, and a second clamping member; the first clamping member has one end attached to a first end of the base plate and an opposite end pointing to a direction toward the fixed seat; the second clamping member has one end attached to a second end of the base plate and an opposite end pointing to the direction toward the fixed seat; the first clamping member and the second clamping member are configured to clamp the second photographic equipment on the base plate; and the first clamping member and the second clamping member are further configured to turn inward to be stacked on the base plate.

2. The support stand for photography according to claim 1, wherein the mounting portion is connected to the fixed seat; the extension arm is rotatably connected to the mounting portion; the clamping portion is configured to clamp the second photographic equipment; and the extension arm and the clamping portion are configured to be accommodated in the gap.

3. The support stand for photography according to claim 2, wherein the extension arm comprises a first supporting arm and a second supporting arm; the first supporting arm and the second supporting arm are spaced from each other, and connected at a side where the clamping portion is located; the first supporting arm and the second supporting arm are respectively arranged at two opposite ends of the mounting portion; the mounting portion is further provided with a locking member; and the locking member penetrates through the first supporting arm, the mounting portion and the second supporting arm to rotatably adjust rotational damping between the extension arm and the mounting portion.

4. The support stand for photography according to claim 2, wherein two opposite ends of the extension arm are rotatably connected to the mounting portion and the clamping portion respectively, wherein an axis of rotation between the extension arm and the mounting portion is defined as a first axis, an axis of rotation between the clamping portion and the extension arm is defined as a second axis, and the first axis and the second axis are perpendicular to each other and further perpendicular to the axial direction.

5. The support stand for photography according to claim 4, wherein the base plate rotates around the second axis relative to the extension arm.

6. The support stand for photography according to claim 1, wherein the adapting structure comprises at least one of a structure selected from a threaded shaft, a hole, a quick-release seat and a quick-release plate; and/or, a part of the clamping seat is located at a side of the adapting structure, wherein the part of the clamping seat is configured for clamping the second photographic equipment, and the side of the adapting structure is away from the support main body; and/or, a universal ball is provided at the mounting end, and the fixed seat and the universal ball are connected and swing relatively; and/or, the support main body comprises a central rod and a slider, wherein the mounting end is formed on the central rod, and the slider slides on the central rod along an axial direction of the central rod and moves close to or away from the mounting end; and sides of the plurality of supporting legs are connected to the slider, wherein the sides of the plurality of supporting legs are away from the supporting ends.

7. A support stand for photography, comprising:
a support main body having supporting ends and a mounting end, wherein the supporting ends and the mounting end are positioned oppositely along an axial direction of the support main body; and
an adapting device provided at the mounting end, and comprising a fixed seat and a clamping seat, wherein the fixed seat is provided with an adapting structure; the adapting structure is configured to mount a first photographic equipment; the clamping seat is configured to clamp a second photographic equipment; the clamping seat is rotatably connected to the fixed seat; and the clamping seat is configured to rotate toward a side where the supporting ends are located, such that the clamping seat is arranged side by side with the support main body, wherein a length direction of the clamping seat is parallel to the axial direction of the support main body when the clamping seat is arranged side by side with the support main body;
wherein the clamping seat comprises a mounting portion, a clamping portion, and an extension arm between the mounting portion and the clamping portion; the clamping portion comprises a base plate, a first clamping member, and a second clamping member; the first clamping member has one end attached to a first end of the base plate and an opposite end pointing to a direction toward the fixed seat; the second clamping member has one end attached to a second end of the base plate and an opposite end pointing to the direction toward the fixed seat; the first clamping member and the second clamping member are configured to clamp the second photographic equipment on the base plate; and the first clamping member and the second clamping member are further configured to turn inward to be stacked on the base plate.

8. The support stand for photography according to claim 7, wherein the mounting portion is connected to the fixed seat; the extension arm is rotatably connected to the mounting portion; the clamping portion is configured to clamp the second photographic equipment; and the extension arm and the clamping portion are arranged side by side with the support main body.

9. The support stand for photography according to claim 8, wherein the extension arm comprises a first supporting arm and a second supporting arm; the first supporting arm and the second supporting arm are spaced from each other, and connected at a side where the clamping portion is located; the first supporting arm and the second supporting arm are respectively arranged at two opposite ends of the mounting portion; the mounting portion is further provided with a locking member; and the locking member penetrates through the first supporting arm, the mounting portion and the second supporting arm to rotatably adjust rotational damping between the extension arm and the mounting portion.

10. The support stand for photography according to claim 8, wherein two opposite ends of the extension arm are rotatably connected to the mounting portion and the clamping portion respectively, wherein an axis of rotation between the extension arm and the mounting portion is defined as a first axis, an axis of rotation between the clamping portion and the extension arm is defined as a second axis, and the first axis and the second axis are perpendicular to each other and further perpendicular to the axial direction.

11. The support stand for photography according to claim 10, wherein the base plate rotates around the second axis relative to the extension arm.

12. The support stand for photography according to claim 7, wherein the adapting structure comprises at least one of a structure selected from a threaded shaft, a hole, a quick-release seat and a quick-release plate; and/or, a part of the clamping seat is located at a side of the adapting structure, wherein the part of the clamping seat is configured for clamping the second photographic equipment, and the side of the adapting structure is away from the support main body; and/or, a universal ball is provided at the mounting end, and the fixed seat and the universal ball are connected and swing relatively; and/or, the support main body comprises a central rod and a slider, wherein the mounting end is formed on the central rod, and the slider slides on the central rod along an axial direction of the central rod and moves close to or away from the mounting end; and sides of the plurality of supporting legs are connected to the slider, wherein the sides of the plurality of supporting legs are away from the supporting ends.

13. A support stand for photography, comprising:
a support main body having supporting ends and a mounting end, wherein the supporting ends and the mounting end are positioned oppositely along an axial direction of the support main body; and
an adapting device provided at the mounting end, and comprising a fixed seat and a clamping seat, wherein the fixed seat is provided with an adapting structure; the adapting structure is configured to mount a first photographic equipment; the clamping seat is configured to clamp a second photographic equipment; the clamping seat is rotatably connected to the fixed seat; and the clamping seat is configured to rotate toward a side where the supporting ends are located, wherein a length direction of the clamping seat is parallel to the axial direction of the support main body when the clamping seat is arranged adjacent to the support main body;
wherein the clamping seat comprises a mounting portion, a clamping portion, and an extension arm between the mounting portion and the clamping portion; the clamping portion comprises a base plate, a first clamping member, and a second clamping member; the first clamping member has one end attached to a first end of the base plate and an opposite end pointing to a direction toward the fixed seat; the second clamping member has one end attached to a second end of the base plate and an opposite end pointing to the direction toward the fixed seat; the first clamping member and the second clamping member are configured to clamp the second photographic equipment on the base plate; and the first clamping member and the second clamping member are further configured to turn inward to be stacked on the base plate.

14. The support stand for photography according to claim 13, wherein the mounting portion is connected to the fixed seat; the extension arm is rotatably connected to the mounting portion; the clamping portion is configured to clamp the second photographic equipment; and a length direction of each of the extension arm and the clamping portion is parallel to the axial direction.

15. A support stand for photography, comprising:
a support main body having supporting ends and a mounting end, wherein the supporting ends and the mounting end are positioned oppositely along an axial direction of the support main body; and
an adapting device provided at the mounting end, and comprising a fixed seat and a clamping seat, wherein the fixed seat is provided with an adapting structure; the adapting structure is configured to mount a first photographic equipment; the clamping seat comprises a mounting portion, a clamping portion, and an extension arm between the mounting portion and the clamping portion; the mounting portion is connected to the fixed seat; the clamping portion is configured to clamp a second photographic equipment; two opposite ends of the extension arm are rotatably connected to the mounting portion and the clamping portion respectively, wherein an axis of rotation between the extension arm and the mounting portion is defined as a first axis, an axis of rotation between the clamping portion and the extension arm is defined as a second axis, and the first axis and the second axis are perpendicular to each other, wherein a length direction of the clamping seat is parallel to the axial direction of the support main body when the clamping seat is arranged adjacent to the support main body;
wherein the clamping portion comprises a base plate, a first clamping member, and a second clamping member; the first clamping member has one end attached to a first end of the base plate and an opposite end pointing to a direction toward the fixed seat; the second clamping member has one end attached to a second end of the base plate and an opposite end pointing to the direction toward the fixed seat; the first clamping member and the second clamping member are configured to clamp the second photograph equipment on the base plate; and the first clamping member and the second clamping member are further configured to turn inward to be stacked on the base plate.

16. The support stand for photography according to claim 15, wherein the first axis is perpendicular to the axial direction of the support main body, and the second axis is perpendicular to the axial direction of the support main body.

17. The support stand for photography according to claim 15, wherein the base plate rotates around the second axis relative to the extension arm.

18. The support stand for photography according to claim 15, wherein the extension arm comprises a first supporting arm and a second supporting arm; the first supporting arm and the second supporting arm are spaced from each other, and connected at a side where the clamping portion is located; the first supporting arm and the second supporting arm are respectively arranged at two opposite ends of the mounting portion; the mounting portion is further provided with a locking member; and the locking member penetrates through the first supporting arm, the mounting portion and the second supporting arm to rotatably adjust rotational damping between the extension arm and the mounting portion.

19. The support stand for photography according to claim 15, wherein the clamping seat is configured to move to a storage state; and in the storage state, the extension arm abuts against the support main body through the clamping portion.

20. The support stand for photography according to claim 15, wherein the adapting structure comprises at least one of a structure selected from a threaded shaft, a hole, a quick-release seat and a quick-release plate; and/or, a part of the clamping seat is located at a side of the adapting structure, wherein the part of the clamping seat is configured for clamping the second photographic equipment, and the side of the adapting structure is away from the support main body; and/or, a universal ball is provided at the mounting end, and the fixed seat and the universal ball are connected and swing relatively; and/or, the support main body comprises a central rod and a slider, wherein the mounting end is formed on the central rod, and the slider slides on the central rod along an axial direction of the central rod and moves close to or away from the mounting end; and sides of a plurality of supporting legs are connected to the slider, wherein the sides of the plurality of supporting legs are away from the supporting ends.
